(19) United States
(12) Patent Application Publication
(10) Pub. No.: US 2026/0369862 A1
(43) Pub. Date: Nov. 19, 2026

(54) ANTENNA DEVICE

(71) Applicant: YOKOWO CO., LTD., Tokyo (JP)

(72) Inventors: Tadashi TSUKAHARA, Tomioka-shi, Gunma (JP); Toshihiko FUJII, Tomioka-shi, Gunma (JP); Seiya HIROKI, Tomioka-shi, Gunma (JP)

(73) Assignee: YOKOWO CO., LTD., Tokyo (JP)

(21) Appl. No.: 19/130,121

(22) PCT Filed: Nov. 13, 2023
(86) PCT No.: PCT/JP2023/040715

§ 371 Date: May 15, 2025

(30) Foreign Application Priority Data
Nov. 22, 2022 (JP) 2022-186266

(51) Int. Cl. H01Q 1/04; H01Q 1/02; H01Q 1/12

(52) U.S. Cl. CPC H01Q 1/04; H01Q 1/02; H01Q 1/12

(57) ABSTRACT

An antenna device includes a housing, an antenna portion housed in the housing, a cable electrically connected to the antenna portion, a waterproof pad surrounding at least a part of the antenna portion, and a grommet through which the cable passes, in which at least a part of the waterproof pad and at least a part of the grommet overlap each other.

### TECHNICAL FIELD

The present invention relates to an antenna device.

### BACKGROUND ART

In recent years, various antenna devices including an antenna accommodated in a housing have been developed. As described in Patent Document 1, for example, a cable connected to the antenna is drawn from the housing when the antenna is accommodated in the housing.

### RELATED DOCUMENT

### Patent Document

Patent Document 1: Japanese Unexamined Patent Publication No. 2017-98835

### SUMMARY OF THE INVENTION

### Technical Problem

A member for waterproofing the surroundings of the antenna in the housing may be provided when the antenna is accommodated in the housing. A member for waterproofing a portion of the housing allowing passage of the cable may be provided when the cable is drawn from the housing. In this case, however, the assembly of the antenna device may be relatively difficult to improve, and the size of the antenna device may be relatively difficult to reduce.

An example of the object of the present invention is to balance the improvement in the assembly of the antenna device and the reduction in the size of the antenna device while ensuring waterproofness of the antenna device. Other objects of the present invention will become apparent from the description of the present specification.

### Solution to Problem

An aspect of the present invention is an antenna device including:
a housing;
an antenna portion housed in the housing;
a cable electrically connected to the antenna portion;
a waterproof pad surrounding at least a portion of the antenna portion; and
a grommet through which the cable passes,
in which at least a portion of the waterproof pad and at least a portion of the grommet overlap each other.

According to the above aspect of the present invention, the improvement in the assembly of the antenna device and the reduction in the size of the antenna device can be balanced while ensuring the waterproof of the antenna device.

### BRIEF DESCRIPTION OF THE DRAWINGS

FIG. 1 An exploded perspective view of an antenna device according to an embodiment.

FIG. 2 A perspective view of a second grommet according to the embodiment and the surroundings.

FIG. 3 A cross-sectional view perpendicular to an X direction of a base, a case, a waterproof pad, a second grommet, and a second cable of the antenna device according to the embodiment.

FIG. 4 A cross-sectional view perpendicular to a Y direction of the base, the case, a first grommet, and a first cable of the antenna device according to the embodiment.

FIG. 5 A perspective view of an inside of the base of the antenna device according to the embodiment.

FIG. 6 A perspective view of an inside of the case of the antenna device according to the embodiment.

FIG. 7 A perspective view of an antenna portion according to Embodiment.

FIG. 8 A graph showing frequency characteristics of voltage standing wave ratio (VSWR) in 500 MHz to 5000 MHz for the first antenna according to Example 1.1, Example 1.2, and Example 1.3.

FIG. 9 A graph showing frequency characteristics of VSWR in 500 MHz to 1000 MHz for the first antenna according to Example 1.1, Example 1.2, and Example 1.3.

FIG. 10 A graph showing frequency characteristics of VSWR in 500 MHz to 5000 MHz for the second antenna according to Example 1.1, Example 1.2, and Example 1.3.

FIG. 11 A graph showing frequency characteristics of VSWR in 500 MHz to 1000 MHz for the second antenna according to Example 1.1, Example 1.2, and Example 1.3.

FIG. 12 A perspective view of an antenna portion according to Variant 1.

FIG. 13 A perspective view of an antenna portion according to Comparative Example.

FIG. 14 A graph showing frequency characteristics of VSWR in 500 MHz to 5000 MHz for the first antenna according to Variant 1.1 and the first antenna according to Comparative Example 1.1.

FIG. 15 A graph showing frequency characteristics of VSWR in 500 MHz to 5000 MHz for the second antenna according to Variant 1.1 and the second antenna according to Comparative Example 1.1.

FIG. 16 A perspective view of an antenna portion according to Variant 2.

FIG. 17 A graph showing frequency characteristics of VSWR in 500 MHz to 5000 MHz for the first antenna according to Variant 2.1 and the first antenna according to Comparative Example 1.1.

FIG. 18 A graph showing frequency characteristics of VSWR in 500 MHz to 5000 MHz for the second antenna according to Variant 2.1 and the second antenna according to Comparative Example 1.1.

### DESCRIPTION OF EMBODIMENTS

Hereinafter, embodiments and variants of the present invention will be described with reference to the accompanying drawings. In all drawings, the same constituent elements are denoted by the same reference signs, and detailed description thereof will not be repeated.

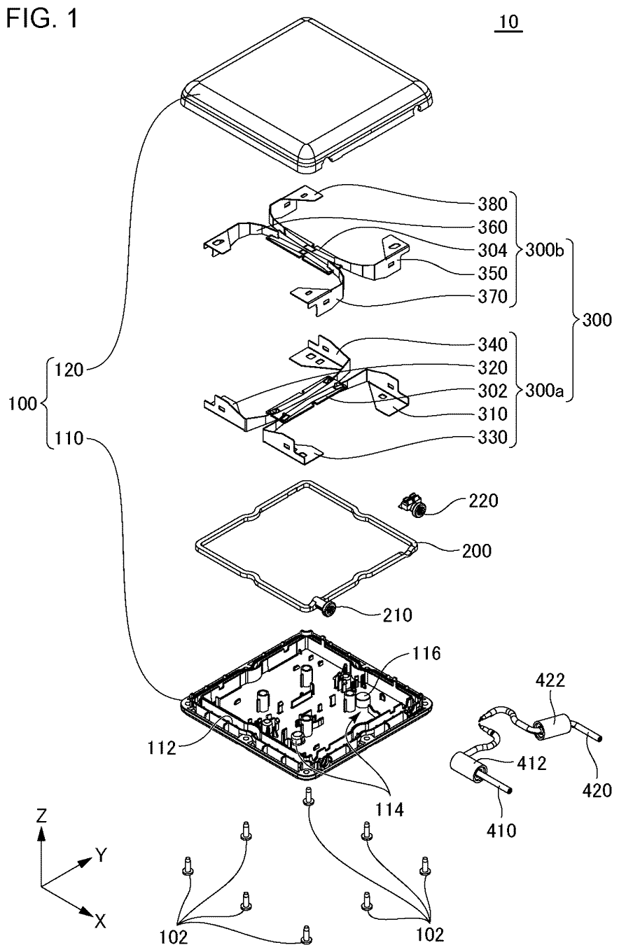

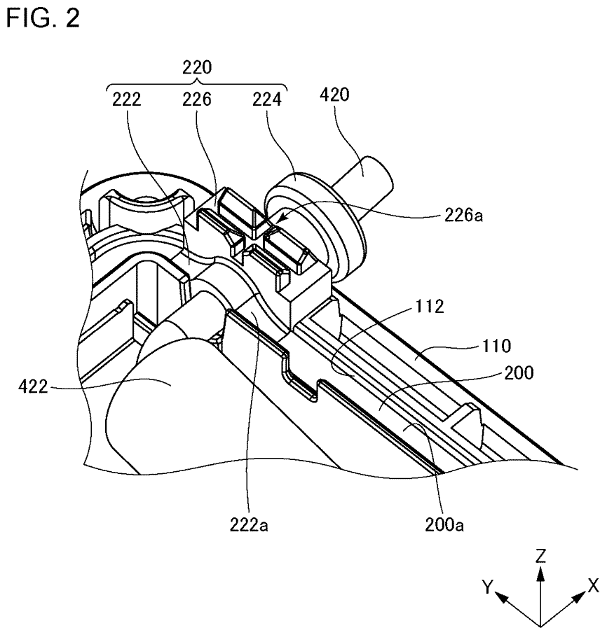

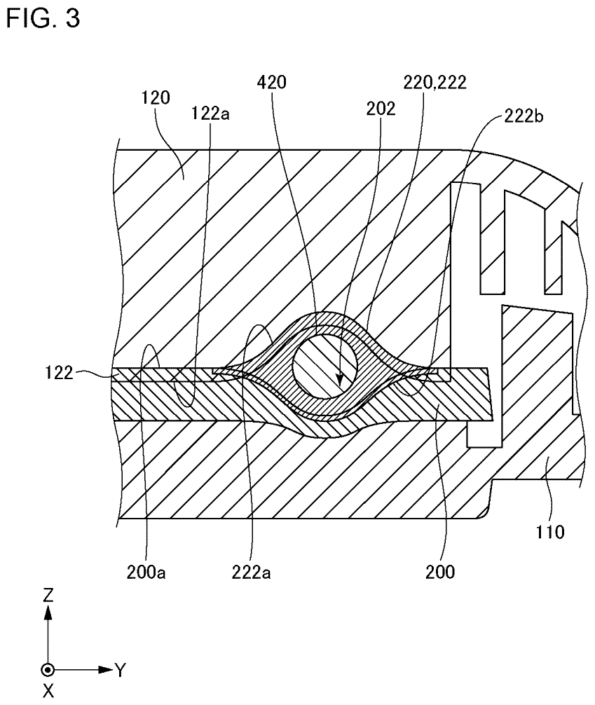

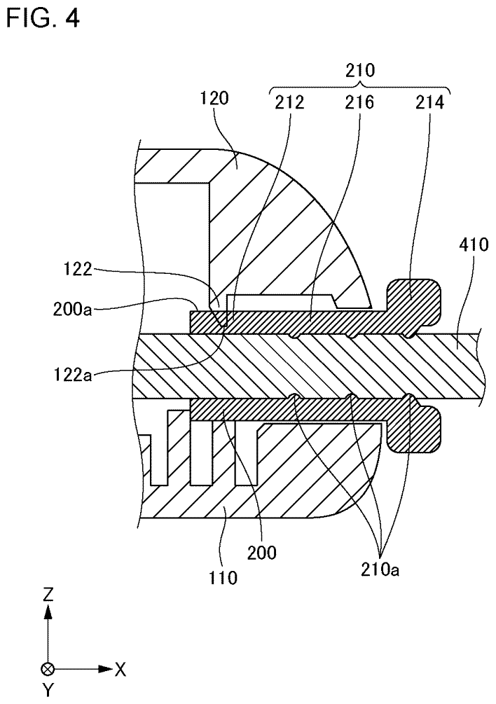

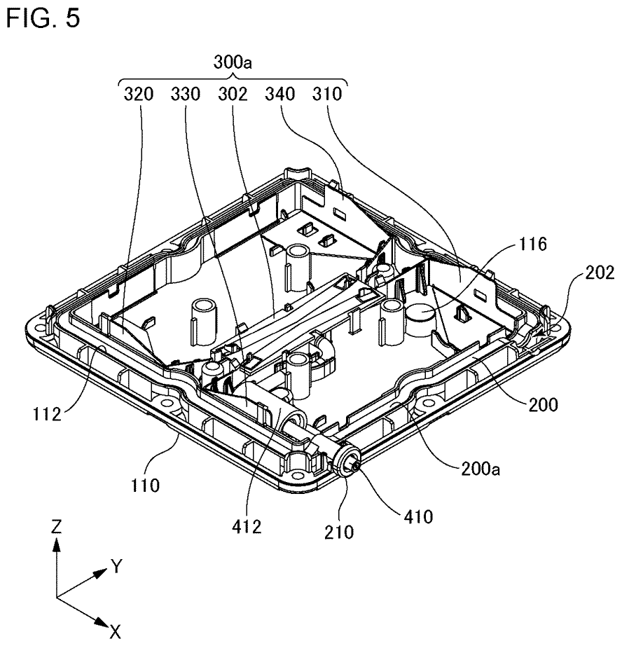

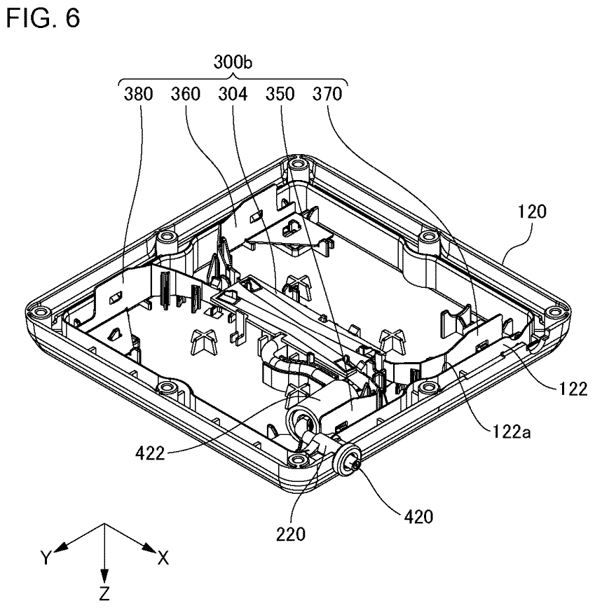

FIG. 1 is an exploded perspective view of an antenna device 10 according to the embodiment. FIG. 2 is a perspective view of a second grommet 220 according to the embodiment and the surroundings. FIG. 3 is a cross-sectional view perpendicular to the X direction of a base 110, a case 120, a waterproof pad 200, a second grommet 220, and a second cable 420 of the antenna device 10 according to the embodiment. FIG. 4 is a cross-sectional view perpendicular to the Y direction of the base 110, the case 120, a first grommet 210, and a first cable 410 of the antenna device 10 according to the embodiment. FIG. 5 is a perspective view of the inside of the base 110 of the antenna device 10 according to the embodiment. FIG. 6 is a perspective view of the inside of the case 120 of the antenna device 10 according to the embodiment.

In each drawing, the X axis, the Y axis, and the Z axis indicating the X direction, the Y direction, and the Z direction respectively are shown for description. The Z direction is a direction parallel to the arrangement direction of the base 110 and the case 120. The X direction is one of directions perpendicular to the Z direction. The Y direction is one of the directions perpendicular to the Z direction and the X direction. Hereinafter, as necessary, a side indicated by the arrow of the X axis will be referred to as a +X side, and a side opposite to the side indicated by the arrow of the X axis will be referred to as a-X side. Hereinafter, as necessary, a side indicated by the arrow of the Y axis will be referred to as a +Y side, and a side opposite to the side indicated by the arrow of the Y axis will be referred to as a −Y side. Hereinafter, as necessary, a side indicated by the arrow of the Z axis will be referred to as a +Z side, and a side opposite to the side indicated by the arrow of the Z axis will be referred to as a −Z side. In some drawings, the white circle with the black dot indicating the X axis, the Y axis, or the Z axis indicates that the arrow of the X axis, the Y axis, or the Z axis points from the back to the front of the paper surface. In some drawings, the white circle with the X indicating the X axis, the Y axis, or the Z axis indicates that the arrow of the X axis, the Y axis, or the Z axis points from the front to the back of the paper surface. In an example, the Z direction is a direction parallel to the vertical direction, and each of the X direction and the Y direction is a direction parallel to a horizontal direction perpendicular to the vertical direction. In this example, the X direction, the Y direction, and the Z direction are, for example, a front-rear direction, a left-right direction, and an up-down direction of the antenna device 10 respectively. The relationship between the X direction, the Y direction, the Z direction, the vertical direction, and the horizontal direction, however, may vary depending on the object on which the antenna device 10 is mounted. For example, the Z direction may be parallel to the horizontal direction depending on the object on which the antenna device 10 is mounted.

Hereinafter, as necessary, a plane perpendicular to the X direction is referred to as a YZ plane, a plane perpendicular to the Y direction is referred to as a ZX plane, a plane perpendicular to the Z direction is referred to as an XY plane, and a direction perpendicular to the Z direction is referred to as an XY plane direction.

Hereinafter, as necessary, a side between the +X side and the +Y side, a side between the −X side and the +Y side, a side between the −X side and the −Y side, and a side between the +X side and the −Y side are referred to as a +X+Y side, a −X+Y side, a −X−Y side, and a +X−Y side respectively as viewed from the +Z side or the −Z side. Hereinafter, as necessary, a side between the +Y side and the +Z side, a side between the −Y side and the +Z side, a side between the −Y side and the −Z side, and a side between the +Y side and the −Z side are referred to as a +Y+Z side, a −Y+Z side, a −Y−Z side, and a +Y−Z side respectively as viewed from the +X side or the −X side. Hereinafter, as necessary, a side between the +Z side and the +X side, a side between the −Z side and the +X side, a side between the −Z side and the −X side, and a side between the +Z side and the −X side are referred to as a +Z+X side, a −Z+X side, a −Z−X side, and a +Z−X side respectively as viewed from the +Y side or the −Y side.

The antenna device 10 will be described with reference to FIG. 1.

The antenna device 10 includes a housing 100, a waterproof pad 200, a first grommet 210, a second grommet 220, an antenna portion 300, a first cable 410, and a second cable 420. The antenna device 10 may further include a circuit board, not shown, housed in the housing 100 as necessary. The housing 100 includes a base 110 and a case 120. The antenna portion 300 includes a first antenna 300a and a second antenna 300b. The first antenna 300a includes a first substrate 302, a first element 310, a second element 320, a third element 330, and a fourth element 340. The second antenna 300b includes a second substrate 304, a fifth element 350, a sixth element 360, a seventh element 370, and an eighth element 380. The first cable 410 is provided with a first ferrite core 412. The second cable 420 is provided with a second ferrite core 422.

The base 110 has a substantially square shape having a pair of sides extending substantially parallel to the X direction and another pair of sides extending substantially parallel to the Y direction as viewed from the +Z side. The shape of the base 110, however, is not limited to the shape according to the embodiment.

The case 120 has substantially the same shape as the base 110 as viewed from the +Z side. The case 120 covers a space on the +Z side of the base 110. The base 110 and the case 120 are attached to each other by a plurality of screws 102. In the embodiment, eight screws 102 are provided at eight positions of four corner portions of the base 110 and substantially the center portion of each side of the base 110 as viewed from the +Z side. The number of screws 102 and the position where the screws 102 are provided, however, are not limited to the example according to the embodiment. The base 110 and the case 120 are attached to each other to form the housing 100. The housing 100 defines an accommodation space in which the antenna portion 300, the first ferrite core 412, and the second ferrite core 422 are accommodated.

A surrounding groove 112 is provided on the +Z side surface of the base 110. As viewed from the +Z side, the surrounding groove 112 surrounds a region in which the antenna portion 300, the first ferrite core 412, and the second ferrite core 422 are disposed. The surrounding groove 112 has a substantially square shape having a pair of sides extending substantially parallel to the X direction and another pair of sides extending substantially parallel to the Y direction as viewed from the +Z side. A recess recessed toward the center of the base 110 in the XY plane direction is provided at a substantially center portion of each side of the surrounding groove 112 as viewed from the +Z side. A space for attaching the screw 102 is formed at the substantially center portion of each side of the base 110 by the recess of the surrounding groove 112.

Two columnar protrusions 114 are provided on the +Z side surface of the base 110. The two columnar protrusions 114 are arranged substantially parallel to each other in the Y direction. A recess portion recessed toward the +Z side is defined on the −Z side surface of the base 110 by each columnar protrusion 114. A communication hole communicating with the accommodation space inside the housing 100 is provided on the +Z side surface of the −Y side columnar protrusion 114. The communication holes are covered with the vent filter 116. Accordingly, the air in the accommodation space inside the housing 100 can be discharged to the outside through the communication hole and the vent filter 116, and the deformation of the housing 100 can be prevented when the accommodation space inside the housing 100 is at a high temperature. The vent filter 116 restrains foreign substances such as dust and moisture outside the housing 100 from entering the accommodation space inside the housing 100. The air inside the housing 100 can be therefore allowed to escape to the outside while maintaining the waterproof and the dustproof inside the housing 100. The +Y side columnar protrusion 114 is not provided with a communication hole communicating with the accommodation space inside the housing 100.

The +Y side columnar protrusions 114 may not be covered with the vent filter 116. When neither of the two columnar protrusions 114 is covered with the vent filter 116, a communication hole communicating with the accommodation space inside the housing 100 may not be provided in either of the two columnar protrusions 114. In this case, the accommodation space inside the housing 100 can be sealed.

The waterproof pad 200 is an elastic material such as rubber. The waterproof pad 200 can waterproof the surroundings of the antenna portion 300, the first ferrite core 412, and the second ferrite core 422 in the housing 100. The waterproof pad 200 is embedded in the surrounding groove 112 as viewed from the +Z side. As viewed from the +Z side, the waterproof pad 200 has a substantially square shape having a pair of sides extending substantially parallel to the X direction and another pair of sides extending substantially parallel to the Y direction, as does the surrounding groove 112. As viewed from the +Z side, a recess recessed toward the center of the base 110 in the XY plane direction is provided at the substantially center of each side of the waterproof pad 200, as is the substantially center of each side of the surrounding groove 112.

The first grommet 210 is an elastic material such as rubber. The first grommet 210 can waterproof a portion of the housing 100 through which the first cable 410 passes. The first grommet 210 is integrated with the waterproof pad 200 to be one part. In the example shown in FIG. 1, the first grommet 210 is provided in the −Y side portion of the +X side edge of the waterproof pad 200. The number of components of the member for waterproofing the surroundings of the antenna portion 300 in the housing 100 and the member for waterproofing the portion of the housing 100 allowing passage of the first cable 410 can be therefore reduced as compared with the case where the waterproof pad 200 and the first grommet 210 are separate bodies.

The second grommet 220 is an elastic material such as rubber. The second grommet 220 can waterproof a portion of the housing 100 through which the second cable 420 passes. The second grommet 220 is a separate body from the waterproof pad 200. In the example shown in FIG. 1, the second grommet 220 overlaps the +Y side portion of the +X side edge of the waterproof pad 200 in the Z direction. At least a part of the waterproof pad 200 and at least a part of the second grommet 220 accordingly overlap each other in the Z direction.

In the embodiment, the antenna portion 300 operates as a fifth generation mobile communication system (5G) antenna. The antenna portion 300, however, may be an antenna different from the 5G antenna. At least a part of the first antenna 300a and at least a part of the second antenna 300b overlap each other in the Z direction. Each of the first substrate 302 and the second substrate 304 is, for example, a printed circuit board (PCB). Each of the first element 310, the second element 320, the third element 330, the fourth element 340, the fifth element 350, the sixth element 360, the seventh element 370, and the eighth element 380 is a conductor such as a sheet metal. Each element may be printed pattern on a substrate. The first element 310, the second element 320, the third element 330, and the fourth element 340 are positioned on the +X+Y side, the −X−Y side, the +X−Y side, and the −X+Y side with respect to the first substrate 302 respectively as viewed from the +Z side. The fifth element 350, the sixth element 360, the seventh element 370, and the eighth element 380 are positioned on the +X+Y side, the −X−Y side, the +X−Y side, and the −X+Y side with respect to the second substrate 304 respectively as viewed from the +Z side.

The first cable 410 is a coaxial cable. One end of the first cable 410 is electrically connected to the first substrate 302 by soldering for example. In the embodiment, at least a part of the one end of the first cable 410 is located between the +Z side surface of the base 110 and the −Z side surface of the first substrate 302 in the Z direction. The other end of the first cable 410 is drawn to the +X side of the housing 100 through the first grommet 210.

The first ferrite core 412 is provided to reduce a noise current flowing in the first cable 410. The first ferrite core 412 is provided on the −X side of the first grommet 210. The first ferrite core 412 is attached to the base 110. The first ferrite core 412 is disposed substantially parallel to the X direction as viewed from the +Z side. The first ferrite core 412 is disposed substantially parallel to the X direction as viewed from the +Y side or the −Y side. The first ferrite core 412, however, may be inclined with respect to the X direction as viewed from the +Y side or the −Y side.

The second cable 420 is a coaxial cable. One end of the second cable 420 is electrically connected to the second substrate 304 by soldering for example. In the embodiment, at least a part of the one end of the second cable 420 is located between the −Z side surface of the case 120 and the +Z side surface of the second substrate 304 in the Z direction. The other end of the second cable 420 is drawn to the +X side of the housing 100 through the second grommet 220.

The second ferrite core 422 is provided to reduce the noise current flowing in the second cable 420. The second ferrite core 422 is provided on the −X side of the second grommet 220. The second ferrite core 422 is attached to the case 120. The second ferrite core 422 is disposed substantially parallel to the Y direction as viewed from the −Z side. The second ferrite core 422 is inclined with respect to the Y direction as viewed from the +X side or the −X side. The second ferrite core 422, however, may be disposed substantially parallel to the Y direction as viewed from the +X side or the −X side.

Next, the base 110, the case 120, the waterproof pad 200, the first grommet 210, and the second grommet 220 will be described with reference to FIGS. 2 to 4 and, as necessary, FIGS. 5 and 6. In the second cable 420 shown in FIG. 3, the entire second cable 420 including the core wire, braiding, and the like of the second cable 420 is hatched as one solid. The same applies to the first cable 410 shown in FIG. 4.

As shown in FIGS. 3, 4, and 6, the case 120 has a pressing rib 122. The pressing rib 122 protrudes from the case 120 toward the −Z side. As shown in FIG. 6, as viewed from the −Z side, the pressing rib 122 surrounds a region in which the antenna portion 300, the first ferrite core 412, and the second ferrite core 422 are disposed.

As shown in FIG. 4, the first grommet 210 has a first proximal end portion 212, a first protruding portion 214, and a first communication portion 216. The first grommet 210 is connected to the waterproof pad 200 at the first proximal end portion 212. The first protruding portion 214 protrudes from the +X side surfaces of the base 110 and the case 120 toward the +X side. The first communication portion 216 is disposed between the first proximal end portion 212 and the first protruding portion 214 in the X direction. The first proximal end portion 212 and the first protruding portion 214 communicate with each other via the first communication portion 216.

As shown in FIGS. 2 and 3, the second grommet 220 has a second proximal end portion 222, a second protruding portion 224, and a second communication portion 226. As shown in FIG. 2, at least a portion of the second proximal end portion 222 and at least a portion of the waterproof pad 200 overlap and contact with each other in the Z direction. The size of the waterproof pad 200 and the second grommet 220 in the X direction can be therefore reduced as compared with the case where the second proximal end portion 222 is displaced to the +X side or the −X side from the +X side edge of the waterproof pad 200. The second protruding portion 224 protrudes from the +X side surfaces of the base 110 and the case 120 toward the +X side. The second communication portion 226 is disposed between the second proximal end portion 222 and the second protruding portion 224 in the X direction. The second proximal end portion 222 and the second protruding portion 224 are connected to each other via the second communication portion 226. As shown in FIG. 2, a fixing groove 226a is provided on a +Z side surface of the second communication portion 226. As viewed from the +Z side, the fixing groove 226a is defined in a substantially +shape by four elastic ribs such as rubber provided on the +Z side surface of the second communication portion 226.

FIG. 3 depicts, by lines, the position of the distal end 122a of the pressing rib 122, the position of the pressed surface 200a of the waterproof pad 200, the position of the first surface 222a of the second proximal end portion 222, and the position of the second surface 222b of the second proximal end portion 222. The distal end 122a is −Z side one end of the pressing rib 122. The pressed surface 200a is a +Z side surface of the waterproof pad 200. In FIG. 3, the position of the pressed surface 200a depicted by the line indicates the position of the pressed surface 200a when the waterproof pad 200 is not pressed by the pressing rib 122. The first surface 222a is the +Z side surface of the second proximal end portion 222. In FIG. 3, the position of the first surface 222a depicted by the line indicates the position of the first surface 222a when the second proximal end portion 222 is not pressed by the pressing rib 122. The second surface 222b is the −Z side surface of the second proximal end portion 222. As shown in FIGS. 3 and 5, the pressed surface 200a of the waterproof pad 200 defines a recess portion 202. The recess portion 202 overlaps and contacts with the second proximal end portion 222 in the Z direction. As shown in FIGS. 2 and 3, the first surface 222a of the second grommet 220 is curved as viewed from the X direction. Specifically, the substantially center portion in Y direction of the first surface 222a is convex toward the +Z side, and both end portions in the Y direction of the first surface 222a are convex toward the −Z side as viewed from the X direction. As shown in FIG. 3, the second surface 222b of the second proximal end portion 222 is curved as viewed from the X direction. Specifically, the substantially center portion in Y direction of the second surface 222b is convex toward the −Z side, and both end portions in the Y direction of the second surface 222b are convex toward the +Z side as viewed from the X direction.

As shown in FIGS. 3 and 4, the pressing rib 122 presses the pressed surface 200a of the waterproof pad 200 toward the −Z side when the base 110 and the case 120 are attached to each other. The region surrounded by the waterproof pad 200 as viewed in the Z direction can be waterproofed accordingly.

As shown in FIG. 3, when the base 110 and the case 120 are attached to each other, the pressing rib 122 presses the first surface 222a of the second proximal end portion 222 toward the −Z side. In this state, the pressed surface 200a of the waterproof pad 200 at the recess portion 202 and the second surface 222b of the second proximal end portion 222 are in contact with each other. Water can be therefore restrained from entering the interface between the pressed surface 200a of the waterproof pad 200 at the recess portion 202 and the second surface 222b of the second proximal end portion 222.

As shown in FIG. 3, when the pressed surface 200a and the first surface 222a are pressed toward the −Z side by the pressing rib 122, a position of a portion of the pressed surface 200a pressed by the pressing rib 122 and a position of a portion of the first surface 222a pressed by the pressing rib 122 coincide with the position of the distal end 122a depicted by the line in FIG. 3. The pressed surface 200a of the waterproof pad 200 at the both side portions in the Y direction of the second proximal end portion 222 and the first surface 222a of the second proximal end portion 222 are therefore substantially flush with each other along the distal end 122a in the portion of the pressed surface 200a pressed by the pressing rib 122 and the portion of the first surface 222a pressed by the pressing rib 122. Water can be therefore restrained from entering the interface between the pressed surface 200a of the waterproof pad 200 and the second surface 222b of the second proximal end portion 222 as compared with the case where a step in the Z direction is present between the pressed surface 200a of the waterproof pad 200 at the both side portions in the Y direction of the second proximal end portion 222 and the first surface 222a of the second proximal end portion 222. Especially in the example shown in FIG. 3, as described above, the both side portions in the Y direction of the first surface 222a of the second proximal end portion 222 is a curve that is convex toward the −Z side as viewed from the X direction. The pressed surface 200a of the waterproof pad 200 at the both side portions in the Y direction of the second proximal end portion 222 and the first surface 222a of the second proximal end portion 222 can be therefore easily substantially flush with each other as compared with the case where the both side portions in the Y direction of the first surface 222a of the second proximal end portion 222 are convex on the +Z side as viewed from the X direction. A step in the Z direction, however, may be present between the pressed surface 200a of the waterproof pad 200 at the both side portions in the Y direction of the second proximal end portion 222 and the first surface 222a of the second proximal end portion 222.

As shown in FIGS. 3 and 5, at least a portion of the second proximal end portion 222 is embedded in the recess portion 202. In the examples shown in FIGS. 3 and 5, the shape of the recess portion 202 substantially coincides with the shape of the second surface 222b of the second proximal end portion 222. At least a portion of the second proximal end portion 222 can be therefore easily embedded in the recess portion 202 as compared with the case where the shape of the recess portion 202 does not match the shape of the second surface 222b of the second proximal end portion 222. When at least a portion of the second proximal end portion 222 is embedded in the recess portion 202, the total height of the waterproof pad 200 and the second proximal end portion 222 in the Z direction can be reduced as compared with the case where the second proximal end portion 222 is not embedded in the recess portion 202. When at least a portion of the second proximal end portion 222 is embedded in the recess portion 202, the pressed surface 200a of the waterproof pad 200 and the first surface 222a of the second proximal end portion 222 can be easily substantially flush with each other, as compared with the case where the second proximal end portion 222 is not embedded in the recess portion 202.

As shown in FIG. 4, a plurality of waterproof ribs 210a is provided on the inner peripheral surfaces of the first protruding portion 214 and the first communication portion 216. The plurality of waterproof ribs 210a is arranged substantially parallel to each other in the X direction. Each waterproof rib 210a has a substantially exact circular annular shape as viewed in the X direction. Each waterproof rib 210a is an elastic material such as rubber. The diameter of a region surrounded by the waterproof rib 210a as viewed in the X direction is smaller than the diameter of the first cable 410. Each waterproof rib 210a therefore can press the outer peripheral surface of the first cable 410. Water can be therefore prevented from easily entering between the inner peripheral surface of the first grommet 210 and the outer peripheral surface of the first cable 410.

As shown in FIG. 4, the waterproof rib 210a is not provided on the inner peripheral surface of the first proximal end portion 212. That is, the waterproof rib 210a is provided in a portion different from a portion pressed by the pressing rib 122 in the first grommet 210. Even if the waterproof rib 210a is provided on the inner peripheral surface of the first proximal end portion 212, the waterproof rib 210a may be deformed into an elliptical annular shape by the pressing of the pressing rib 122 as viewed in the X direction. In this case, it may be difficult to sufficiently secure the waterproof of the waterproof rib 210a. In the example shown in FIG. 4, contrarily, any waterproof rib 210a can be prevented from being pressed by the waterproof rib 210a. All the waterproof ribs 210a can be therefore prevented from being deformed into the elliptical annular shape as viewed in the X direction.

Next, an example of a method of assembling the antenna device 10 according to the embodiment will be described with reference to FIGS. 5 and 6. In this example, the antenna device 10 according to the embodiment is assembled as follows.

First, the base 110 and the case 120 are prepared.

Next, as shown in FIG. 5, the waterproof pad 200, the first grommet 210, the first antenna 300a, the first cable 410, and the first ferrite core 412 are attached to the base 110. An example of the attachment shown in FIG. 5 is as follows. Hereinafter, in the description of the example of the attachment shown in FIG. 5, the inner drawn portion of the first cable 410 refers to a portion of the first cable 410 drawn from the first grommet 210 to the inside of the base 110.

First, the first cable 410 is passed through the first grommet 210 and the first ferrite core 412. Thus, the waterproof pad 200, the first grommet 210, and the first cable 410 are temporarily assembled with each other. The length of the inner drawn portion of the first cable 410 when the waterproof pad 200, the first grommet 210, and the first cable 410 are temporarily assembled with each other is longer than the length of the inner drawn portion of the first cable 410 when the antenna device 10 is finally assembled. That is, the inner drawn portion of the first cable 410 has an excess length portion when the waterproof pad 200, the first grommet 210, and the first cable 410 are temporarily assembled with each other. Next, the first substrate 302 and one end of the inner drawn portion of the first cable 410 are electrically connected to each other by soldering.

Next, the base 110 and each of the first element 310, the second element 320, the third element 330, and the fourth element 340 are assembled with each other.

Next, the base 110 and the first substrate 302 are assembled to each other. Next, each of the four corners of the first substrate 302 and the proximal end portion of each of the first element 310, the second element 320, the third element 330, and the fourth element 340 are electrically connected to each other by soldering. In the embodiment, at least a part of one end of the inner drawn of the first cable 410 is located between the +Z side surface of the base 110 and the −Z side surface of the first substrate 302 in the Z direction.

Next, the base 110 and the first ferrite core 412 are assembled with each other while the first cable 410 is routed.

Next, the base 110, the waterproof pad 200, and the first grommet 210 are assembled with each other while drawing the excess length portion of the inner drawn portion of the first cable 410 toward the +X side of the first grommet 210. In the method of this example, therefore, the workability for allowing the first cable 410 to pass through the first grommet 210 can be improved as compared with the case where the first cable 410 is passed through the first grommet 210 after the base 110, the waterproof pad 200, and the first grommet 210 are assembled with each other.

Thus, the attachment shown in FIG. 5 is conducted. The attachment order shown in FIG. 5, however, is not limited to the example described above.

As shown in FIG. 6, the second grommet 220, the second antenna 300b, the second cable 420, and the second ferrite core 422 are attached to the case 120 at the same time, before or after the attachment shown in FIG. 5. An example of the attachment shown in FIG. 6 is as follows. Hereinafter, in the description of the example of the attachment shown in FIG. 6, the inner drawn portion of the second cable 420 refers to a portion of the second cable 420 drawn from the second grommet 220 to the inside of the case 120.

First, the second cable 420 is passed through the second grommet 220 and the second ferrite core 422. Thus, the second grommet 220 and the second cable 420 are temporarily assembled to each other. The length of the inner drawn portion of the second cable 420 when the second grommet 220 and the second cable 420 are temporarily assembled to each other is longer than the length of the inner drawn portion of the second cable 420 when the antenna device 10 is finally assembled. That is, the inner drawn portion of the second cable 420 has an excess length portion when the second grommet 220 and the second cable 420 are temporarily assembled with each other. Next, the second substrate 304 and one end of the inner drawn portion of the second cable 420 are electrically connected to each other by soldering.

Next, the case 120 and each of the fifth element 350, the sixth element 360, the seventh element 370, and the eighth element 380 are assembled with each other.

Next, the case 120 and the second substrate 304 are assembled to each other. Next, each of the four corners of the second substrate 304 and the proximal end portion of each of the fifth element 350, the sixth element 360, the seventh element 370, and the eighth element 380 are electrically connected to each other by soldering. In the embodiment, at least a part of one end of the inner drawn portion of the second cable 420 is located between the −Z side surface of the case 120 and the +Z side surface of the second substrate 304 in the Z direction.

Next, the case 120 and the second ferrite core 422 are assembled to each other while the second cable 420 is routed.

Next, the case 120 and the second grommet 220 are assembled with each other while drawing the excess length portion of the inner drawn portion of the second cable 420 toward the +X side of the second grommet 220. In the method of this example, therefore, the workability for allowing the second cable 420 to pass through the second grommet 220 can be improved as compared with the case where the second cable 420 is passed through the second grommet 220 after the case 120 and the second grommet 220 are assembled with each other.

As described with reference to FIG. 2, the fixing groove 226a is provided on the +Z side surface of the second communication portion 226 of the second grommet 220. The case 120 is provided with a rib having a substantially+shape, not shown, press-fitted into the fixing groove 226a. The rotation of the second grommet 220 about the axis of the second cable 420 can be suppressed by press fitting the rib of the case 120 into the fixing groove 226a. For example, the rotation of the second grommet 220 can be suppressed even if the second cable 420 is twisted when the excess length portion of the inner drawn portion of the second cable 420 is drawn toward the +X side of the second grommet 220.

Thus, the attachment shown in FIG. 6 is conducted. The attachment order shown in FIG. 6, however, is not limited to the example described above.

After the attachment shown in FIG. 5 and the attachment shown in FIG. 6, the base 110 and the case 120 are attached to each other by the plurality of screws 102 shown in FIG. 1. Thus, the antenna device 10 is assembled.

In the embodiment, the waterproof pad 200 and the second grommet 220 are separate bodies. Accordingly, the attachment of the waterproof pad 200 to the base 110 and the attachment of the second grommet 220 to the case 120 can be performed independently of each other. If the waterproof pad 200 and the second grommet 220 are integrated, for example, the work of electrically connecting the second substrate 304 and the second cable 420 while the second antenna 300b is attached to the case 120 and the work of drawing the second cable 420 from the second grommet 220 are relatively difficult to do independently. In the embodiment, therefore, the assembly of the antenna device 10 can be improved as compared with the case where the waterproof pad 200 and the second grommet 220 are integrated. In the embodiment, the size of the antenna device 10 in the X direction can be reduced as described above as compared with the case where the waterproof pad 200 and the second grommet 220 are not in contact to overlap each other in the Z direction. The improvement of the assembly of the antenna device 10 and the reduction in the size of the antenna device 10 can be therefore balanced while ensuring the waterproof of the antenna device 10 as compared with the case where the waterproof pad 200 and the second grommet 220 are integrated with each other or the case where the waterproof pad 200 and the second grommet 220 are not in contact to overlap each other in the Z direction.

In the embodiment, the waterproof pad 200 and the first grommet 210 are integrated with each other. The first grommet 210, however, may be separate from the waterproof pad 200 in the same way as the second grommet 220. In this case, at least a portion of the waterproof pad 200 and at least a portion of the first grommet 210 may be in contact to overlap each other in the Z direction.

Next, an example of a method of using the antenna device 10 will be described.

The antenna device 10 is used outdoors, for example. The antenna device 10, however, may be used indoors. When the antenna device 10 is used outdoors, the antenna device 10 may be exposed to moisture such as rain or snow. In the antenna device 10, however, waterproofing is realized by the waterproof pad 200, the first grommet 210, and the second grommet 220. Accordingly, the operation of the antenna device 10 is not hindered even if the antenna device 10 is exposed to moisture such as rain or snow. The antenna device 10 is mounted on, for example, an automobile. Alternatively, the antenna device 10 is provided in a vending machine installed outdoors, a ticket vending machine installed in outdoor coin parking, or the like. When the antenna device 10 is provided to a housing such as a vending machine or a ticket machine, the antenna device 10 can be provided outside the housing, not inside the housing. The use application of the antenna device 10, however, is not limited to these examples.

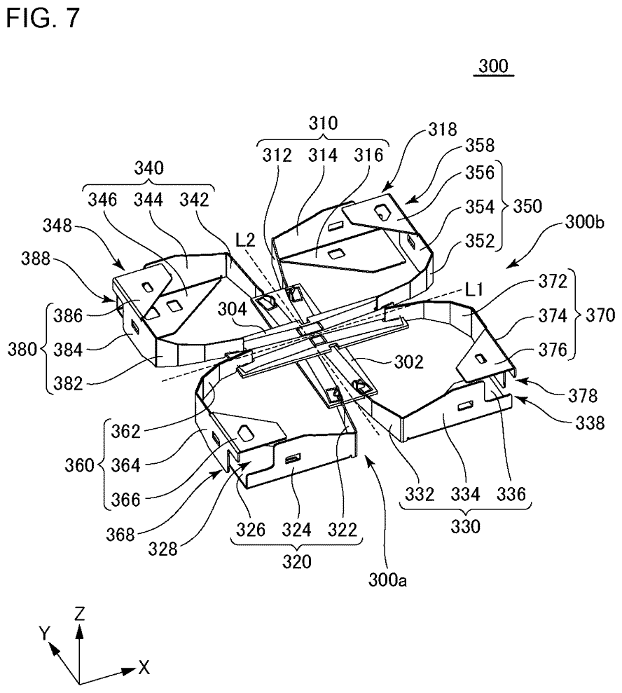

FIG. 7 is a perspective view of an antenna portion 300 according to Embodiment.

The antenna portion 300 is operable as a loop antenna in a low frequency band. The antenna portion 300 is operable as a dipole antenna in a middle frequency band. The antenna portion 300 is operable as a traveling wave antenna in a high frequency band. Accordingly, the antenna portion 300 is operable as a wideband antenna.

The first substrate 302 has a substantially rectangular shape having a pair of short sides substantially parallel to the X direction and a pair of long sides substantially parallel to the Y direction as viewed from the +Z side. The second substrate 304 has a substantially rectangular shape having a pair of long sides substantially parallel to the X direction and a pair of short sides substantially parallel to the Y direction as viewed from the +Z side. The second substrate 304 is disposed on the +Z side of the first substrate 302. As viewed from the +Z side, the center point of the first substrate 302 in the XY plane direction and the center point of the second substrate 304 in the XY plane direction overlap each other in the Z direction. For the sake of description, FIG. 7 depicts a first imaginary line L1 and a second imaginary line L2. As viewed from the +Z side, the first imaginary line L1 passes substantially parallel to the X direction through the center points of the first substrate 302 and the second substrate 304 in the XY plane direction. As viewed from the +Z side, the second imaginary line L2 passes substantially parallel to the Y direction through the center points of the first substrate 302 and the second substrate 304 in the XY plane direction.

The first element 310, the second element 320, the third element 330, and the fourth element 340 will be described.

The first element 310 includes a first arm portion 312, a first side portion 314, and a first extending portion 316. A first notch 318 is provided at the distal end portion of the first side portion 314. The second element 320 includes a second arm portion 322, a second side portion 324, and a second extending portion 326. A second notch 328 is provided at the distal end portion of the second side portion 324. The third element 330 includes a third arm portion 332, a third side portion 334, and a third extending portion 336. A third notch 338 is provided at the distal end portion of the third side portion 334. The fourth element 340 includes a fourth arm portion 342, a fourth side portion 344, and a fourth extending portion 346. A fourth notch 348 is provided at the distal end portion of the fourth side portion 344. The first cable 410 can be drawn from the first substrate 302 through at least one of the first notch 318, the second notch 328, the third notch 338, or the fourth notch 348.

The first element 310, the second element 320, the third element 330, and the fourth element 340 are disposed substantially symmetrically with respect to the center point of the first substrate 302 in the XY plane direction as viewed from the +Z side. Specifically, as viewed from the +Z side, a pair of the first element 310 and the fourth element 340 and a pair of the second element 320 and the third element 330 are disposed substantially symmetrically with respect to the first imaginary line L1. As viewed from the +Z side, a pair of the first element 310 and the third element 330 and a pair of the second element 320 and the fourth element 340 are disposed substantially symmetrically with respect to the second imaginary line L2. Accordingly, the first element 310, the second element 320, the third element 330, and the fourth element 340 have substantially the same shape as viewed from the +Z side.

The second element 320 will be described. Unless otherwise specified, the discussion below regarding the second element 320 are also applicable to the first element 310, the third element 330, and the fourth element 340, except that the first element 310, the third element 330, and the fourth element 340 are disposed substantially symmetrically with respect to the second element 320.

The second arm portion 322 includes a proximal end portion that is electrically connected to the −X−Y side corner of the first substrate 302. The proximal end portion of the second arm portion 322 and the −X−Y side corner of the first substrate 302 are electrically connected to each other by soldering, for example. The second arm portion 322 extends from the −X−Y side corner of the first substrate 302 toward the −X−Y side. The second side portion 324 and the second extending portion 326 extend from the second arm portion 322 toward the −X side. The second side portion 324 is bent toward the −X side with respect to the second arm portion 322. The second side portion 324 is disposed substantially parallel to the ZX plane. The second extending portion 326 is bent at a substantially right angle toward the +Y side with respect to the second side portion 324. The second extending portion 326 is disposed substantially parallel to the XY plane.

The width of the second element 320 increases away from the proximal end portion of the second element 320. Specifically, the width of the second arm portion 322 gradually increases away from the proximal end portion of the second element 320. The total width of the second arm portion 322, the second side portion 324, and the second extending portion 326 gradually increases from the second arm portion 322 to the second side portion 324 and the second extending portion 326 when the second arm portion 322, the second side portion 324, and the second extending portion 326 are developed in substantially the same plane. Specifically, as viewed from the −Y side, the width of the second side portion 324 in the Z direction gradually increases from the second arm portion 322 to the second side portion 324. The shape of the second extending portion 326 is substantially symmetrical with the shape of the first extending portion 316 with respect to the center point of the first substrate 302 in the XY plane direction. The second extending portion 326 accordingly has a substantially trapezoidal shape of which the lower base is the fold of the second side portion 324 and the second extending portion 326 as viewed from the +Z side. The width of the second extending portion 326 in the Y direction therefore gradually increases from the second arm portion 322 to the second extending portion 326 as viewed from the +Z side.

The second notch 328 is provided at the +Z−X side corner of the distal end portion of the second side portion 324 as viewed from the −Y side. The width of the second notch 328 in the Z direction can take any length in a range equal to or less than the maximum width of the second side portion 324 in the Z direction. The resonance frequency of the low frequency band around the 600 MHz band of the first antenna 300a can be optionally adjusted according to the length of the second notch 328 in the X direction. Specifically, the longer the length of the second notch 328 in the X direction is, the smaller the area of the second element 320 is. Accordingly, the longer the length of the second notch 328 in the X direction is, the shorter the wavelength of the resonance frequency of the first antenna 300a is according to the area of the second element 320. As a result, the longer the length of the second notch 328 in the X direction is, the higher the resonance frequency of the first antenna 300a is. Conversely, the shorter the length of the second notch 328 in the X direction is, the larger the area of the second element 320 is. Accordingly, the shorter the length of the second notch 328 in the X direction is, the longer the wavelength of the resonance frequency of the first antenna 300a is according to the area of the second element 320. As a result, the shorter the length of the second notch 328 in the X direction is, the lower the resonance frequency of the first antenna 300a is.

The fifth element 350, the sixth element 360, the seventh element 370, and the eighth element 380 will be described.

The fifth element 350 includes a fifth arm portion 352, a fifth side portion 354, and a fifth extending portion 356. A fifth notch 358 is provided at the distal end portion of the fifth side portion 354. The sixth element 360 includes a sixth arm portion 362, a sixth side portion 364, and a sixth extending portion 366. A sixth notch 368 is provided at the distal end portion of the sixth side portion 364. The seventh element 370 includes a seventh arm portion 372, a seventh side portion 374, and a seventh extending portion 376. A seventh notch 378 is provided at the distal end portion of the seventh side portion 374. The eighth element 380 includes an eighth arm portion 382, an eighth side portion 384, and an eighth extending portion 386. An eighth notch 388 is provided at the distal end portion of the eighth side portion 384. The second cable 420 can be drawn from the second substrate 304 through at least one of the fifth notch 358, the sixth notch 368, the seventh notch 378, or the eighth notch 388. In the example shown in FIG. 1, for example, the first cable 410 is drawn from the first substrate 302 through the seventh notch 378, and the second cable 420 is drawn from the second substrate 304 through the fifth notch 358.

The fifth element 350, the sixth element 360, the seventh element 370, and the eighth element 380 are disposed substantially symmetrically with respect to the center point of the second substrate 304 in the XY plane direction as viewed from the +Z side. Specifically, as viewed from the +Z side, a pair of the fifth element 350 and the eighth element 380 and a pair of the sixth element 360 and the seventh element 370 are disposed substantially symmetrically with respect to the first imaginary line L1. As viewed from the +Z side, a pair of the fifth element 350 and the seventh element 370 and a pair of the sixth element 360 and the eighth element 380 are disposed substantially symmetrically with respect to the second imaginary line L2. Accordingly, the fifth element 350, the sixth element 360, the seventh element 370, and the eighth element 380 have substantially the same shape as viewed from the +Z side.

The sixth element 360 will be described. Unless otherwise specified, the discussion below regarding the sixth element 360 are also applicable to the fifth element 350, the seventh element 370, and the eighth element 380, except that the fifth element 350, the seventh element 370, and the eighth element 380 are disposed substantially symmetrically with the fifth element 350.

The sixth arm portion 362 includes a proximal end portion that is electrically connected to the −X−Y side corner of the second substrate 304. The proximal end portion of the sixth arm portion 362 and the −X−Y side corner of the second substrate 304 are electrically connected to each other by soldering, for example. The sixth arm portion 362 extends from the −X−Y side corner of the second substrate 304 toward the −X−Y side. The sixth side portion 364 and the sixth extending portion 366 extend from the sixth arm portion 362 toward the −Y side. The sixth side portion 364 is bent toward the −Y side with respect to the sixth arm portion 362. The sixth side portion 364 is disposed substantially parallel to the YZ plane. The sixth extending portion 366 is bent at a substantially right angle toward the +X side with respect to the sixth side portion 364. The sixth extending portion 366 is disposed substantially parallel to the XY plane. At least a part of the second extending portion 326 and at least a part of the sixth extending portion 366 face each other in the Z direction.

The width of the sixth element 360 increases away from the proximal end portion of the sixth element 360. Specifically, the width of the sixth arm portion 362 gradually increases away from the proximal end portion of the sixth element 360. The total width of the sixth arm portion 362, the sixth side portion 364, and the sixth extending portion 366 gradually increases from the sixth arm portion 362 to the sixth side portion 364 and the sixth extending portion 366 when the sixth arm portion 362, the sixth side portion 364, and the sixth extending portion 366 are developed on substantially the same plane. Specifically, the width of the sixth side portion 364 in the Z direction gradually increases from the sixth arm portion 362 to the sixth side portion 364 as viewed from the −X side. The sixth extending portion 366 has a substantially trapezoidal shape of which the lower base is the fold of the sixth side portion 364 and the sixth extending portion 366 as viewed from the +Z side. The width of the sixth extending portion 366 in the X direction therefore gradually increases from the sixth arm portion 362 to the sixth extending portion 366 as viewed from the +Z side.

The sixth notch 368 is provided at the −Y−Z side corner of the distal end portion of the sixth side portion 364 as viewed from the −X side. The width of the sixth notch 368 in the Z direction can take any length in a range equal to or less than the maximum width of the sixth side portion 364 in the Z direction. The resonance frequency of the low frequency band around the 600 MHz band of the second antenna 300b can be optionally adjusted according to the length of the sixth notch 368 in the Y direction. Specifically, the longer the length of the sixth notch 368 in the Y direction is, the smaller the area of the sixth element 360 is. Accordingly, the longer the length of the sixth notch 368 in the Y direction is, the shorter the wavelength of the resonance frequency of the second antenna 300b is according to the area of the sixth element 360. As a result, the longer the length of the sixth notch 368 in the Y direction is, the higher the resonance frequency of the second antenna 300b is. Conversely, the shorter the length of the sixth notch 368 in the Y direction is, the larger the area of the sixth element 360 is. Accordingly, the shorter the length of the sixth notch 368 in the Y direction is, the longer the wavelength of the resonance frequency of the second antenna 300b is according to the area of the sixth element 360. As a result, the shorter the length of the sixth notch 368 in the Y direction is, the lower the resonance frequency of the second antenna 300b is.

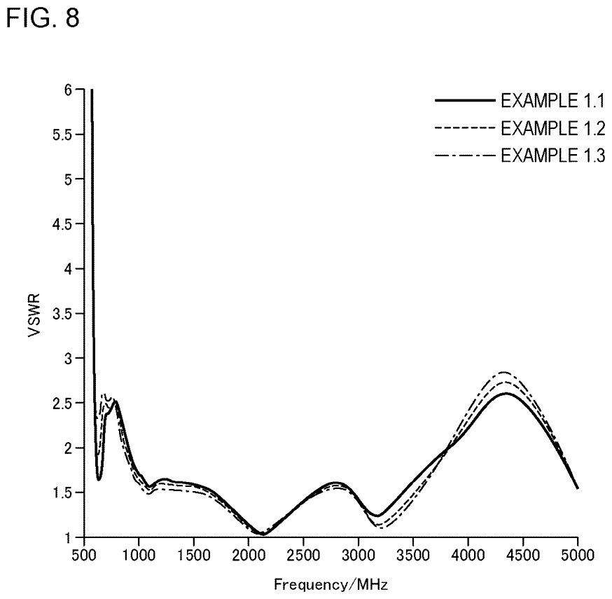

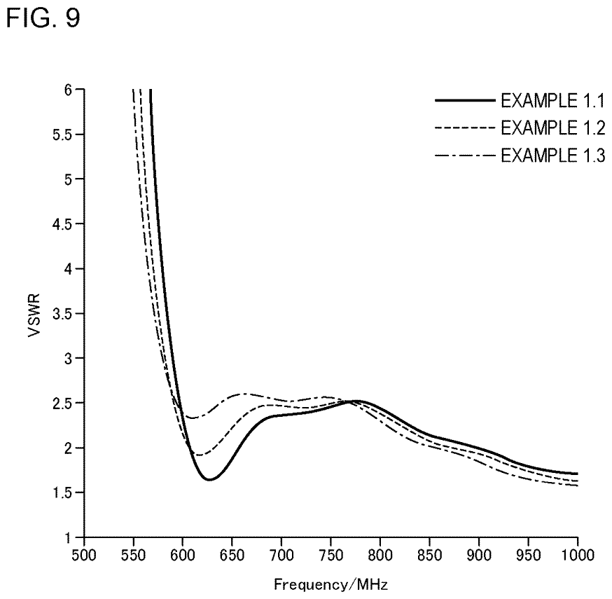

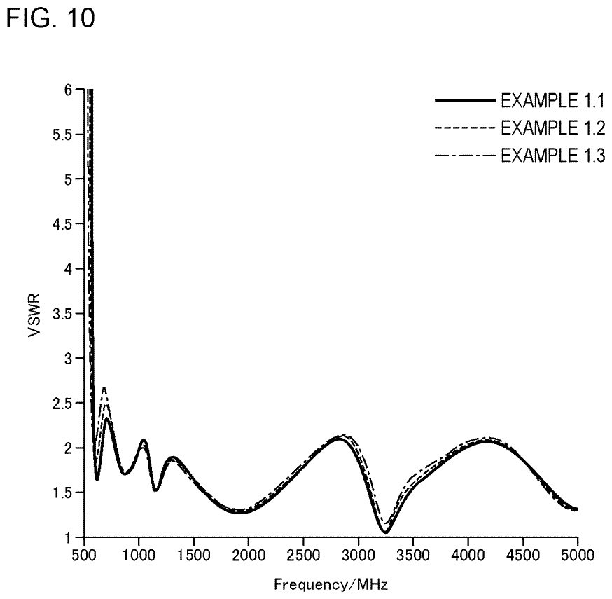

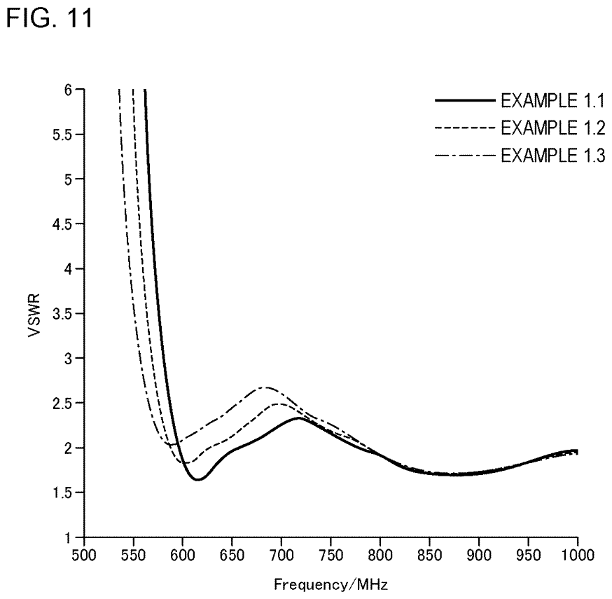

FIG. 8 is a graph showing frequency characteristics of voltage standing wave ratio (VSWR) in 500 MHz to 5000 MHz for the first antenna 300a according to Example 1.1, Example 1.2, and Example 1.3. FIG. 9 is a graph showing frequency characteristics of VSWR in 500 MHz to 1000 MHz for the first antenna 300a according to Example 1.1, Example 1.2, and Example 1.3. FIG. 10 is a graph showing frequency characteristics of VSWR in 500 MHz to 5000 MHz for the second antenna 300b according to Example 1.1, Example 1.2, and Example 1.3. FIG. 11 is a graph showing frequency characteristics of VSWR in 500 MHz to 1000 MHz for the second antenna 300b according to Example 1.1, Example 1.2, and Example 1.3.

The horizontal axis of each of the graphs of FIGS. 8 to 11 is a frequency (unit: MHz). The vertical axis of each graph of FIGS. 8 to 11 is VSWR.

The antenna portions 300 according to Examples 1.1, 1.2, and 1.3 are examples of the antenna portion 300 according to the embodiment. The X direction length of the notch provided at the distal end portion of each of the first element 310, the second element 320, the third element 330, and the fourth element 340 decreases from Example 1.1 to Example 1.2 to Example 1.3. The Y direction length of the notch provided at the distal end portion of each of the fifth element 350, the sixth element 360, the seventh element 370, and the eighth element 380 decreases from Example 1.1 to Example 1.2 to Example 1.3.

As shown in FIGS. 8 to 11, the VSWR in both the first antenna 300a and the second antenna 300b has the local minimum value around the 600 MHz band. In both the first antenna 300a and the second antenna 300b, the resonance frequency at which the VSWR has the local minimum value decreases from Example 1.1 to Example 1.2 to Example 1.3. This result suggests that the longer the length of the notch provided at the distal end portion of each element is, the higher the resonance frequency of each antenna is, and that the shorter the length of the notch provided at the distal end portion of each element is, the lower the resonance frequency of each antenna is. Thus, the resonance frequency of the low frequency band around the 600 MHz band of each antenna can be optionally adjusted according to the size of the notch provided at the distal end portion of each element.

In the embodiment, the notch is provided at the distal end portion of each element of both the first antenna 300a and the second antenna 300b. The notch, however, may be provided to the distal end portion of each element of only one of the first antenna 300a and the second antenna 300b. In the embodiment, notches are provided at the distal end portions of all four elements of the first antenna 300a. A notch, however, may be provided at the distal end portion of at least one of the four elements of the first antenna 300a. The same applies to the second antenna 300b. In this case, the resonance frequency of the low frequency band around the 600 MHz band of the antenna provided with the notch can also be optionally adjusted according to the size of the notch.

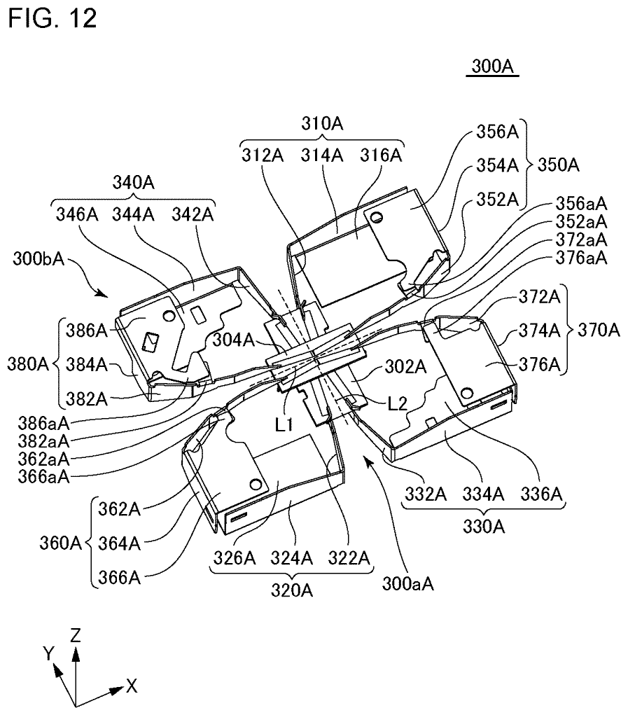

FIG. 12 is a perspective view of an antenna portion 300A according to Variant 1. The antenna portion 300A according to Variant 1 is the same as the antenna portion 300 according to the embodiment except for the following points.

The antenna portion 300A has a first antenna 300aA and a second antenna 300bA. The first antenna 300aA includes a first substrate 302A, a first element 310A, a second element 320A, a third element 330A, and a fourth element 340A. The second antenna 300bA includes a second substrate 304A, a fifth element 350A, a sixth element 360A, a seventh element 370A, and an eighth element 380A.

The first element 310A includes a first arm portion 312A, a first side portion 314A, and a first extending portion 316A. The second element 320A includes a second arm portion 322A, a second side portion 324A, and a third extending portion 336A. The third element 330A includes a third arm portion 332A, a third side portion 334A, and a third extending portion 336A. The fourth element 340A includes a fourth arm portion 342A, a fourth side portion 344A, and a fourth extending portion 346A.

The fifth element 350A includes a fifth arm portion 352A, a fifth side portion 354A, and a fifth extending portion 356A. The fifth arm portion 352A is provided with a first protrusion 352aA. The fifth extending portion 356A is provided with a second protrusion 356aA. The sixth element 360A includes a sixth arm portion 362A, a sixth side portion 364A, and a sixth extending portion 366A. The sixth arm portion 362A is provided with a third protrusion 362aA. The sixth extending portion 366A is provided with a fourth protrusion 366aA. The seventh element 370A includes a seventh arm portion 372A, a seventh side portion 374A, and a seventh extending portion 376A. The seventh arm portion 372A is provided with a fifth protrusion 372aA. The seventh extending portion 376A is provided with a sixth protrusion 376aA. The eighth element 380A includes an eighth arm portion 382A, an eighth side portion 384A, and an eighth extending portion 386A. The eighth arm portion 382A is provided with a seventh protrusion 382aA. The eighth extending portion 386A is provided with an eighth protrusion 386aA.

The first element 310A will be described. Unless otherwise specified, the discussion below regarding the first element 310A are also applicable to the second element 320A, the third element 330A, and the fourth element 340A, except that the second element 320A, the third element 330A, and the fourth element 340A are disposed substantially symmetrically with respect to the first element 310A.

The width of the first element 310A increases away from the proximal end portion of the first element 310A. Specifically, the width of the first arm portion 312A gradually increases away from the proximal end portion of the first element 310A. As viewed from the +Z side, the −Z side outer edge of the first side portion 314A and the −X side outer edge of the first extending portion 316A form a corner portion that is opened at approximately 90° (intersecting each other at an angle of approximately 90°). Specifically, the first extending portion 316A has a substantially rectangular shape of which the long side is the fold of the first side portion 314A and the first extending portion 316A as viewed from the +Z side. The same applies to the second extending portion 326A.

The width of the third element 330A increases away from the proximal end portion of the third element 330A. Specifically, the width of the third arm portion 332A gradually increases away from the proximal end portion of the third element 330A. As viewed from the +Z side, the −Z side outer edge of the third side portion 334A and the −X side outer edge of the third extending portion 336A form a corner portion that is opened at substantially 90°. Specifically, the +Y side outer edge of the third extending portion 336A has a stepped shape as viewed from the +Z side. The same applies to the fourth extending portion 346A.

The VSWR characteristics of the first antenna 300aA in the middle frequency band and the high frequency band can be improved by appropriately adjusting the shape of each extending portion. When the outer edge of each side portion and the outer edge of each extending portion form a corner portion opened at approximately 90°, for example, the VSWR characteristics in the medium frequency band and the high frequency band of the first antenna 300aA around 2500 MHz to 5000 MHz can be improved as compared with the case where the outer edge of each side portion and the outer edge of each extending portion form a corner portion opened at an obtuse angle from each arm portion to each side portion and each extending portion.

In Variant 1, the outer edges of at least a portion of all four elements of the first antenna 300aA form an angle portion that is open at approximately 90°. At least a portion of at least one outer edge of the four elements of the first antenna 300aA, however, may form an angle portion that is open at substantially 90°.

The fifth element 350A will be described. Unless otherwise specified, the discussion below regarding the fifth element 350A are also applicable to the sixth element 360A, the seventh element 370A, and the eighth element 380A, except that the sixth element 360A, the seventh element 370A, and the eighth element 380A are disposed substantially symmetrically with respect to the fifth element 350A.

The first protrusion 352aA protrudes from the +Z side edge of the approximately center portion in the X direction of the fifth arm portion 352A toward the +Y side as viewed from the +Z side. The second protrusion 356aA protrudes from the −X−Y side corner of the fifth extending portion 356A toward the −Y side as viewed from the +Z side. The first protrusion 352aA and the second protrusion 356aA overlap each other in the Z direction. In the example shown in FIG. 12, the second protrusion 356aA is disposed on the +Z side of the first protrusion 352aA. The first protrusion 352aA and the second protrusion 356aA are electrically connected to each other by soldering, for example. The first protrusion 352aA and the second protrusion 356aA are accordingly connection portions that electrically connect the fifth arm portion 352A and the fifth extending portion 356A to each other.

The width of the fifth element 350A increases away from the proximal end portion of the fifth element 350A. Specifically, the width of the fifth arm portion 352A gradually increases from the proximal end portion of the fifth element 350A to the connecting portion between the first protrusion 352aA and the second protrusion 356aA. The connecting portion between the first protrusion 352aA and the second protrusion 356aA can make the width of the fifth arm portion 352A substantially equivalent to the total of the width of the fifth extending portion 356A and the width of the fifth arm portion 352A or the fifth side portion 354A from the connecting portion between the first protrusion 352aA and the second protrusion 356aA to the fifth side portion 354A and the fifth extending portion 356A. Accordingly, the fifth element 350A when the fifth arm portion 352A, the fifth side portion 354A, and the fifth extending portion 356A are developed in substantially the same plane can be similar to an ideal bowtie antenna shape as compared with the case where the first protrusion 352aA and the second protrusion 356aA are not provided. The VSWR characteristics in the medium frequency band and the high frequency band of the second antenna 300bA around 2500 MHz to 5000 MHz can be therefore improved as compared with the case where the first protrusion 352aA and the second protrusion 356aA are not provided.

In Variant 1, all four elements of the second antenna 300bA have a connecting portion that electrically connects predetermined portions of the respective elements to each other. At least one of the four elements of the second antenna 300bA, however, may have a connecting portion that electrically connects a predetermined portion of the at least one element to each other.

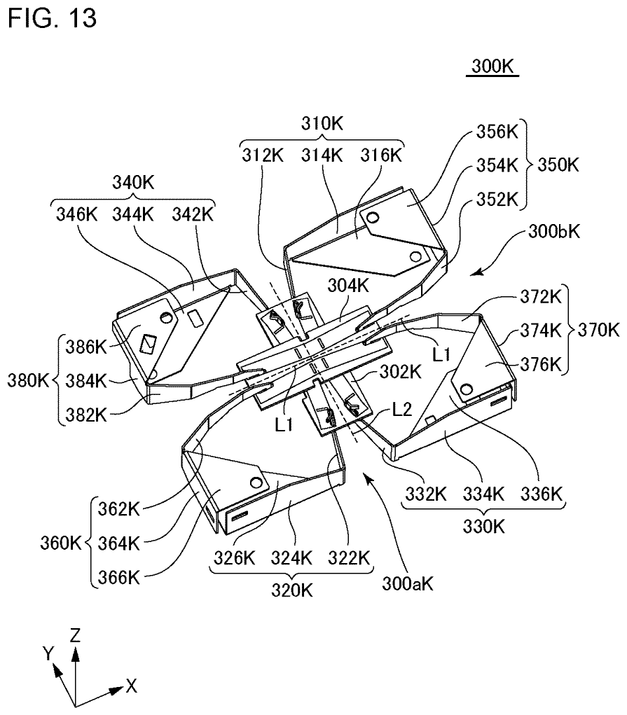

FIG. 13 is a perspective view of an antenna portion 300K according to Comparative Example. The antenna portion 300K according to Comparative Example is the same as the antenna portion 300 according to the embodiment except for the following points.

The antenna portion 300K includes a first antenna 300aK and a second antenna 300bK. The first antenna 300aK includes a first substrate 302K, a first element 310K, a second element 320K, a third element 330K, and a fourth element 340K. The second antenna 300bK includes a second substrate 304K, a fifth element 350K, a sixth element 360K, a seventh element 370K, and an eighth element 380K.

The first element 310K includes a first arm portion 312K, a first side portion 314K, and a first extending portion 316K. The second element 320K includes a second arm portion 322K, a second side portion 324K, and a second extending portion 326K. The third element 330K includes a third arm portion 332K, a third side portion 334K, and a third extending portion 336K. The fourth element 340K includes a fourth arm portion 342K, a fourth side portion 344K, and a fourth extending portion 346K.

The fifth element 350K includes a fifth arm portion 352K, a fifth side portion 354K, and a fifth extending portion 356K. The sixth element 360K includes a sixth arm portion 362K, a sixth side portion 364K, and a sixth extending portion 366K. The seventh element 370K includes a seventh arm portion 372K, a seventh side portion 374K, and a seventh extending portion 376K. The eighth element 380K includes an eighth arm portion 382K, an eighth side portion 384K, and an eighth extending portion 386K.

The distal end portion of each of the first side portion 314, the second side portion 324K, the third side portion 334K, and the fourth side portion 344K according to Comparative Examples is not provided with a notch corresponding to the first notch 318, the second notch 328, the third notch 338, and the fourth notch 348 according to the embodiment. The distal end portion of each of the fifth side portion 354K, the sixth side portion 364K, and the seventh side portion 374K according to Comparative Example is not provided with a notch corresponding to the fifth notch 358, the sixth notch 368, and the seventh notch 378 according to the embodiment.

The first extending portion 316K according to Comparative Example has a substantially trapezoidal shape of which the lower base is the fold of the first side portion 314K and the second side portion 324K as viewed from the +Z side. The same applies to the second extending portion 326K, the third extending portion 336K, and the fourth extending portion 346K according to Comparative Examples.

The fifth element 350K according to Comparative Example is not provided with a protrusion corresponding to the first protrusion 352aA and the second protrusion 356aA according to Variant 1. The same applies to the sixth element 360K, the seventh element 370K, and the eighth element 380K according to Comparative Examples.

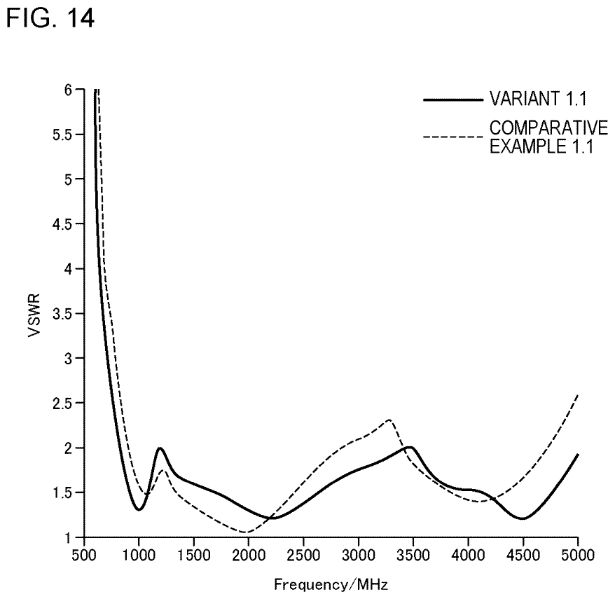

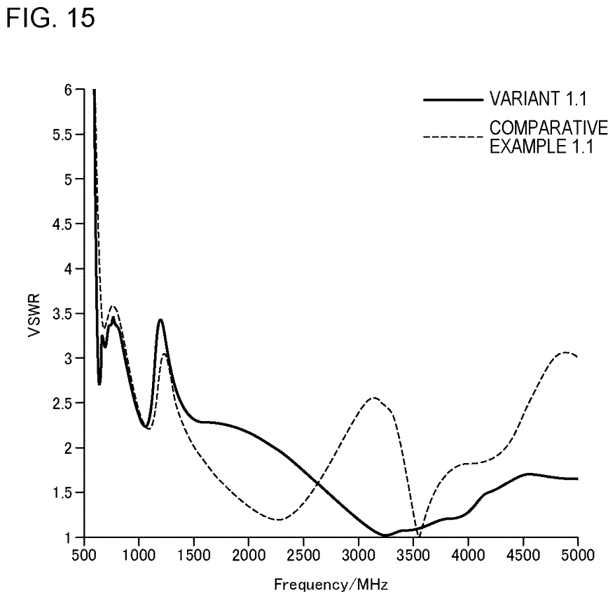

FIG. 14 is a graph showing frequency characteristics of VSWR in 500 MHz to 5000 MHz for the first antenna 300aA according to Variant 1.1 and the first antenna 300aK according to Comparative Example 1.1. FIG. 15 is a graph showing frequency characteristics of VSWR in 500 MHz to 5000 MHz for the second antenna 300bA according to Variant 1.1 and the second antenna 300bK according to Comparative Example 1.1.

The antenna portion 300A according to Variant 1.1 is an example of the antenna portion 300A according to Variant 1.

The antenna portion 300K according to Comparative Example 1.1 is an example of the antenna portion 300K according to Comparative Example.

As shown in FIG. 15, the VSWR of the second antenna 300bA of Variant 1.1 is lower than the VSWR of the second antenna 300bK of Comparative Example 1.1 over almost the entire band of 2500 MHz to 5000 MHz. This result suggests that the VSWR characteristics in the medium frequency band and the high frequency band around 2500 MHz to 5000 MHz of the second antenna 300bB can be better when a connecting portion that electrically connects a predetermined portion of each element of the second antenna 300bB is provided than when the connecting portion that electrically connects the predetermined portion of each element of the second antenna 300bB is not provided.

In Variant 1, each element of the first antenna 300aA does not have a connecting portion that electrically connects a predetermined portion of each element of the first antenna 300aA to each other. Each element of the first antenna 300aA, however, may have a connecting portion that electrically connects a predetermined portion of each element of the first antenna 300aA to each other. In this example, the second antenna 300bB may or may not have a connecting portion that electrically connects predetermined portions of the respective elements of the second antenna 300bB to each other.

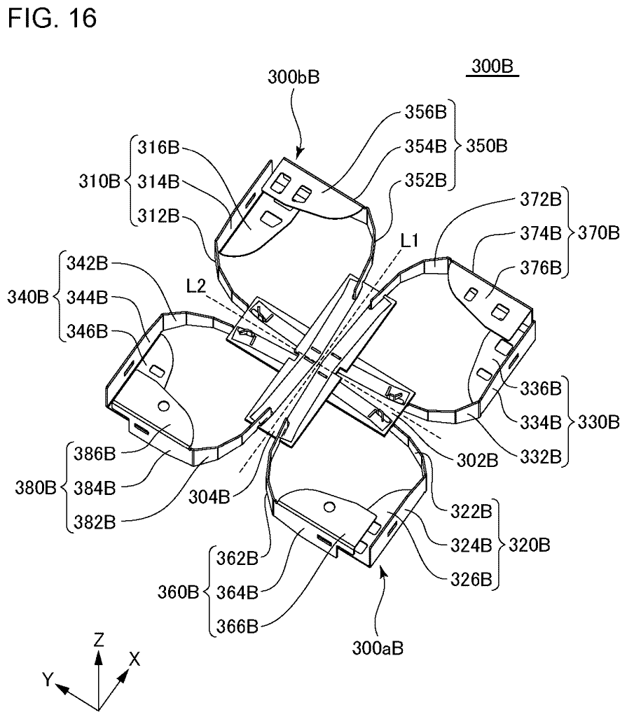

FIG. 16 is a perspective view of an antenna portion 300B according to Variant 2. The antenna portion 300B according to Variant 2 is the same as the antenna portion 300 according to the embodiment except for the following points.

The antenna portion 300B includes a first antenna 300aB and a second antenna 300bB. The first antenna 300aB includes a first substrate 302B, a first element 310B, a second element 320B, a third element 330B, and a fourth element 340B. The second antenna 300bB includes a second substrate 304B, a fifth element 350B, a sixth element 360B, a seventh element 370B, and an eighth element 380B.

The first element 310B includes a first arm portion 312B, a first side portion 314B, and a first extending portion 316B. The second element 320B includes a second arm portion 322B, a second side portion 324B, and a second extending portion 326B. The third element 330B includes a third arm portion 332B, a third side portion 334B, and a third extending portion 336B. The fourth element 340B includes a fourth arm portion 342B, a fourth side portion 344B, and a fourth extending portion 346B.

The fifth element 350B includes a fifth arm portion 352B, a fifth side portion 354B, and a fifth extending portion 356B. The sixth element 360B includes a sixth arm portion 362B, a sixth side portion 364B, and a sixth extending portion 366B. The seventh element 370B includes a seventh arm portion 372B, a seventh side portion 374B, and a seventh extending portion 376B. The eighth element 380B includes an eighth arm portion 382B, an eighth side portion 384B, and an eighth extending portion 386B.

The first element 310B will be described. Unless otherwise specified, the discussion below regarding the first element 310B are also applicable to the sixth element 360B, the seventh element 370B, and the eighth element 380B, except that the sixth element 360B, the seventh element 370B, and the eighth element 380B are disposed to be substantially symmetrical to the fifth element 350B.

As viewed from the +Z side, the width of the first extending portion 316B in the Y direction gradually increases away from the first arm portion 312B. As viewed from the +Z side, the −Y side outer edge of the first extending portion 316B is rounded. Specifically, the first extending portion 316B has a substantially elliptical fan shape with a central angle of approximately 90° as viewed from the +Z side. In this case, the first element 310B can be similar to the ideal semicircular bowtie antenna shape as compared with the case where the −Y side outer edge of the first extending portion 316B has a linear shape as viewed from the +Z side. Accordingly, the VSWR characteristics in the high frequency band around 3250 MHz to 5000 MHz of the first antenna 300aB can be improved as compared with the case where the −Y side outer edge of the first extending portion 316B is a linear shape as viewed from the +Z side.

The fifth element 350B will be described. Unless otherwise specified, the discussion below regarding the fifth element 350B are also applicable to the sixth element 360B, the seventh element 370B, and the eighth element 380B, except that the sixth element 360B, the seventh element 370B, and the eighth element 380B are disposed to be substantially symmetrical to the fifth element 350B.

As viewed from the +Z side, the width of the fifth extending portion 356B in the X direction gradually increases away from the fifth arm portion 352B. As viewed from the +Z side, the −X side outer edge of the fifth extending portion 356B is rounded. Specifically, the fifth extending portion 356B has a substantially elliptical fan shape with a central angle of approximately 90° as viewed from the +Z side. In this case, the fifth element 350B can be similar to the ideal semicircular bowtie antenna shape as compared with the case where the −X side outer edge of the fifth extending portion 356B has a linear shape as viewed from the +Z side. Accordingly, the VSWR characteristics of the second antenna 300bB in a high frequency band around 3250 MHz to 5000 MHz can be improved as compared with the case where the −X side outer edge of the fifth extending portion 356B is a linear shape as viewed from the +Z side.

In Variant 2, at least a portion of the outer edge of each element of both the first antenna 300aB and the second antenna 300bB is rounded. At least a portion of the outer edge of each element of only one of the first antenna 300aB and the second antenna 300bB, however, may be rounded. In Variant 2, at least a portion of the outer edge of all four elements of the first antenna 300aB is rounded. At least a part of at least one outer edge of the four elements of the first antenna 300aB, however, may be rounded. The same applies to the second antenna 300bB.

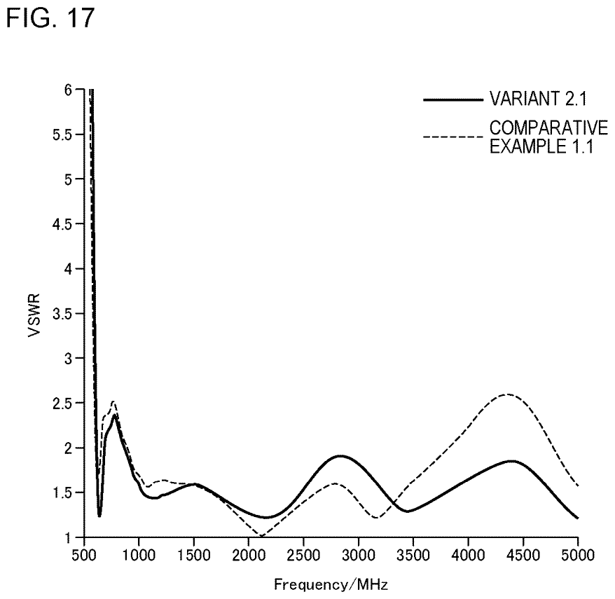

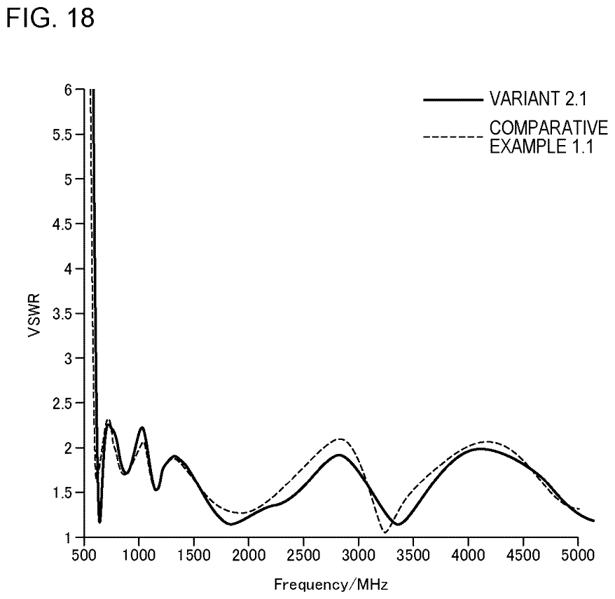

FIG. 17 is a graph showing frequency characteristics of VSWR in 500 MHz to 5000 MHz for the first antenna 300aB according to Variant 2.1 and the first antenna 300aK according to Comparative Example 1.1. FIG. 18 is a graph showing frequency characteristics of VSWR in 500 MHz to 5000 MHz for the second antenna 300bB according to Variant 2.1 and the second antenna 300bK according to Comparative Example 1.1.

The antenna portion 300B according to Variant 2.1 is an example of the antenna portion 300B according to Variant 2.

As shown in FIG. 17, the VSWR of the first antenna 300aB of Variant 2.1 is lower than the VSWR of the first antenna 300aK of Comparative Example 1.1 over almost the entire band of 3250 MHz to 5000 MHz. This result suggests that the VSWR characteristics of the first antenna 300aB in a high frequency band around 3250 MHz to 5000 MHz can be better when at least a part of the outer edge of the element is rounded than when none of the outer edges of the element are rounded.

As shown in FIG. 18, the VSWR of the second antenna 300bB of Variant 2.1 is lower than the VSWR of the second antenna 300bK of Comparative Example 1.1 over almost the entire band of 3250 MHz to 5000 MHz. This result suggests that the VSWR characteristics in the high frequency band around 3250 MHz to 5000 MHz of the second antenna 300bB can be better when at least a part of the outer edge of the element is rounded than when none of the outer edges of the element are rounded.

In Variant 2, the outer edge of at least a portion of each element of both the first antenna 300aB and the second antenna 300bB is rounded. The outer edge of at least a portion of each element of only one of the first antenna 300aB and the second antenna 300bB, however, may be rounded. In this case, the VSWR characteristics in the high frequency band of 3250 MHz to 5000 MHz can also be improved for the antenna having the rounded outer edge of at least a portion of each element.

Although the embodiments and variants of the present invention have been described with reference to the accompanying drawings, these are merely examples of the present invention, and various other configurations may be employed.

For example, the antenna device 10 according to the embodiment includes the antenna portion 300 connected to two cables of the first cable 410 and the second cable 420. The discussion in the embodiment, however, can also be applied to an antenna device including a global navigation satellite system (GNSS) antenna connected to one cable, for example.

In the antenna device 10 according to the embodiment, the base 110 is provided with the surrounding groove 112 in which the waterproof pad 200 is embedded. The surrounding groove 112, however, may be provided on the case 120 instead of the base 110.

According to the present specification, the following aspects of an antenna device are provided.

### Aspect 1.1

In the aspect 1.1, the antenna device includes a housing, an antenna portion housed in the housing, a cable electrically connected to the antenna portion, a waterproof pad surrounding at least a part of the antenna portion, and a grommet through which the cable passes, and at least a part of the waterproof pad and at least a part of the grommet overlap each other.

The “cable” corresponds to the “second cable” of the embodiment described above. The “grommet” corresponds to the “second grommet” of the embodiment described above.

According to the aspect described above, the surroundings of the antenna portion in the housing can be waterproofed by the waterproof pad. A portion of the housing through which the cable passes can be waterproofed by the grommet. In the aspect described above, the assembly of the antenna device can be improved as compared with the case where the waterproof pad and the grommet are integrated. In the aspect described above, the size of the antenna device can be reduced as compared with the case where the waterproof pad and the grommet do not overlap each other. The improvement in the assembly of the antenna device and the reduction in the size of the antenna device can be balanced while ensuring the waterproof of the antenna device as compared with the case where the waterproof pad and the grommet are integrated or the case where the waterproof pad and the grommet do not overlap.

### Aspect 1.2

In the aspect 1.2, the waterproof pad and the grommet have a substantially flush surface pressed by the housing.

According to the aspect described above, the entry of water into the interface between the waterproof pad and the grommet can be restrained as compared with the case where the waterproof pad and the grommet do not have the surface having the substantially flat surface (there is a step between the waterproof pad and the grommet).

### Aspect 1.3

In the aspect 1.3, the waterproof pad defines a recess portion overlapping with at least a portion of the grommet.

According to the aspect described above, the size of the waterproof pad and the grommet in the depth direction of the recess portion can be reduced as compared with the case where the waterproof pad does not define the recess portion. According to the aspect described above, the waterproof pad and the grommet can easily have the substantially flush surface pressed by the housing as compared with the case where the waterproof pad does not define the recess portion.

### Aspect 1.4

In the aspect 1.4, the waterproof pad allows a cable different from the cable to pass therethrough.

According to the aspect described above, the improvement in the assembly of the antenna device and the reduction in the size of the antenna device can be balanced while securing the waterproof of the antenna device as compared with the case where the waterproof pad and the grommet are integrated with each other or the case where the waterproof pad and the grommet do not overlap.

### Aspect 2.1

In the aspect 2.1, the antenna device includes a plurality of elements disposed substantially symmetrically, and a notch is provided at a distal end portion of at least one element of the plurality of elements.

According to the aspect described above, the resonance frequency in the low frequency band of the antenna having the plurality of elements can be optionally adjusted according to the size of the notch provided at the distal end portion of the element. The characteristics of the desired frequency band of the wideband antenna can be adjusted accordingly.

### Aspect 2.2

In the aspect 2.2, the antenna device further includes a plurality of other elements disposed substantially symmetrically, at least a part of the plurality of other elements overlapping at least a part of the plurality of elements, and a notch is provided at a distal end portion of at least one element of the plurality of other elements.

According to the aspect described above, the resonance frequency of the low frequency band of the antenna having the plurality of other elements can be optionally adjusted according to the size of the notch provided at the distal end portion of the other element. The characteristics of the desired frequency band of the wideband antenna can be adjusted accordingly.

### Aspect 3.1

In the aspect 3.1, the antenna device includes a plurality of elements disposed substantially symmetrically, and at least one of the plurality of elements includes a connecting portion that electrically connects predetermined portions of the at least one element to each other.

According to the aspect described above, the antenna can be similar to the ideal bowtie antenna shape as compared with the case where the connecting portion for electrically connecting the predetermined portions of the element to each other is not provided. The VSWR characteristics in the medium frequency band and the high frequency band can be therefore better than when the connection portion is not provided. The characteristics of the desired frequency band of the wideband antenna can be adjusted accordingly.

### Aspect 3.2

In the aspect 3.2, the antenna device further includes a plurality of other elements disposed substantially symmetrically, at least a part of the plurality of other elements overlapping at least a part of the plurality of elements, and at least a part of an outer edge of at least one of the plurality of other elements forms a corner portion that is opened at substantially 90°.

According to the aspect described above, the VSWR characteristics in the middle frequency band and the high frequency band of the antenna having a plurality of other elements can be improved by appropriately adjusting the shapes of the other elements.

### Aspect 4.1

In the aspect 4.1, the antenna device includes a plurality of elements disposed substantially symmetrically, and at least a part of an outer edge of at least one of the plurality of elements is rounded.

According to the aspect described above, the antenna having the plurality of elements can be similar to the ideal semicircular bowtie antenna shape as compared with the case where any portion of the outer edge of the element is not rounded. The VSWR characteristics in the high frequency band can be therefore improved as compared with the case where any portion of the outer edge of the element is not rounded. The characteristics of the desired frequency band of the wideband antenna can be improved accordingly.

### Aspect 4.2

In the aspect 4.2, the antenna device further includes a plurality of other elements disposed substantially symmetrically, at least a part of the plurality of other elements overlapping at least a part of the plurality of elements, and at least a part of an outer edge of at least one of the plurality of other elements is rounded.

According to the aspect described above, the antenna having the plurality of other elements can be similar to the ideal semicircular bowtie antenna shape as compared with the case where none of the outer edges of the other elements are rounded. The VSWR characteristics in the high frequency band can be therefore improved as compared with the case where any portion of the outer edge of the other element is not rounded. The characteristics of the desired frequency band of the wideband antenna can be improved accordingly.

This application claims priority based on Japanese Patent Application No. 2022-186266 filed on Nov. 22, 2022, the entire disclosure of which is incorporated herein by reference.

### REFERENCE SIGNS LIST

10 antenna device, 100 housing, 102 screw, 110 base, 112 surrounding groove, 114 columnar protrusion, 116 vent filter, 120 case, 122 pressing rib, 122a distal end, 200 waterproof pad, 200a pressed surface, 202 recess portion, 210 first grommet, 210a waterproof rib, 212 first proximal end portion, 214 first protruding portion, 216 first communication portion, 220 second grommet, 222 second proximal end portion, 222a first surface, 222b second surface, 224 second protruding portion, 226 second communication portion, 226a fixing groove, 300, 300A, 300B, 300K antenna portion, 300a, 300aA, 300aB, 300aK first antenna, 300b, 300bA, 300bB, 300bK second antenna, 302, 302A, 302B, 302K first substrate, 304, 304A, 304B, 304K second substrate, 310, 310A, 310B, 310K first element, 312, 312A, 312B, 312K first arm portion, 314, 314A, 314B, 314K first side portion, 316, 316A, 316B, 316K first extending portion, 318 first notch, 320, 320A, 320B, 320K second element, 322, 322A, 322B, 322K second arm portion, 324, 324A, 324B, 324K second side portion, 326, 326A, 326B, 326K second extending portion, 328 second notch, 330, 330A, 330B, 330K third element, 332, 332A, 332B, 332K third arm portion, 334, 334A, 334B, 334K third side portion, 336, 336A, 336B, 336K third extending portion, 338 third notch, 340, 340A, 340B, 340K fourth element, 342, 342A, 342B, 342K fourth arm portion, 344, 344A, 344B, 344K fourth side portion, 346, 346A, 346B, 346K fourth extending portion, 348 fourth notch, 350, 350A, 350B, 350K fifth element, 352, 352A, 352B, 352K fifth arm portion, 352aA first protrusion, 354, 354A, 354B, 354K fifth side portion, 356, 356A, 356B, 356K fifth extending portion, 356aA second protrusion, 358 fifth notch, 360, 360A, 360B, 360K sixth element, 362, 362A, 362B, 362K sixth arm portion, 362aA third protrusion, 364, 364A, 364B, 364K sixth side portion, 366, 366A, 366B, 366K sixth extending portion, 366aA fourth protrusion, 368 sixth notch, 370, 370A, 370B, 370K seventh element, 372, 372A, 372B, 372K seventh arm portion, 372aA fifth protrusion, 374, 374A, 374B, 374K seventh side portion, 376, 376A, 376B, 376K seventh extending portion, 376aA sixth protrusion, 378 seventh notch, 380, 380A, 380B, 380K eighth element, 382, 382A, 382B, 382K eighth arm portion, 382aA seventh protrusion, 384, 384A, 384B, 384K eighth side portion, 386, 386A, 386B, 386K eighth extending portion, 386aA eighth protrusion, 388 eighth notch, 410 first cable, 412 first ferrite core, 420 second cable, 422 second ferrite core, L1 first imaginary line, L2 second imaginary line

1. An antenna device comprising:
a housing;
an antenna portion housed in the housing;
a cable electrically connected to the antenna portion;
a waterproof pad surrounding at least a part of the antenna portion; and
a grommet through which the cable passes,
wherein at least a part of the waterproof pad and at least a part of the grommet overlap each other.

2. The antenna device according to claim 1,
wherein the waterproof pad and the grommet have a substantially flush surface pressed by the housing.

3. The antenna device according to claim 1,
wherein the waterproof pad defines a recess portion overlapping at least a part of the grommet.

4. The antenna device according to claim 1,
wherein the waterproof pad allows a cable different from the cable to pass therethrough.
